(19) United States
(12) Patent Application Publication
(10) Pub. No.: US 2006/0071975 A1
(43) Pub. Date: Apr. 6, 2006

(54) Droplet-discharging head, method for manufacturing the same, and droplet-discharging device

(76) Inventors: Yasushi Matsuno, Matsumoto (JP); Akira Sano, Matsumoto (JP)

Correspondence Address: HARNESS, DICKEY & PIERCE, P.L.C., P.O. BOX 828, BLOOMFIELD HILLS, MI, 48303, US

(21) Appl. No.: 11/236,752

(22) Filed: Sep. 27, 2005

(30) Foreign Application Priority Data
Oct. 6, 2004 (JP) 2004-293317

(51) Int. Cl. B41J 2/04

(52) U.S. Cl. 347/54

(57) ABSTRACT

A droplet-discharging head comprising: a nozzle substrate in which a plurality of nozzle holes for discharging droplets are formed; a cavity substrate in which a recess to serve as a discharging chamber for pooling the droplets is formed, the recess having a diaphragm formed in a bottom face thereof; an electrode substrate in which an individual electrode opposite to the diaphragm for driving the diaphragm is formed; and a reservoir substrate having a recess to serve as a common droplet chamber for supplying droplets to the discharging chamber, a penetrating hole for transporting droplets to the discharging chamber from the common droplet chamber, and a nozzle communicating hole for transporting droplets to the nozzle hole from the discharging chamber, wherein the reservoir substrate has the nozzle substrate bonded to one face thereof and has the cavity substrate bonded to the other face thereof.

### RELATED APPLICATIONS

This application claims priority to Japanese Patent Application No. 2004-293317 filed Oct. 6, 2004 which is hereby expressly incorporated by reference herein in its entirety.

### BACKGROUND OF THE INVENTION

1. Technical field

The present invention relates to a droplet-discharging head, a method for manufacturing the same and a droplet-discharging device, and in particular to a droplet-discharging head or the like capable of securing the discharge performance of droplets while suppressing the increase of a passage resistance even if a discharging chamber is densified.

2. Related Art

In recent ink-jet printers of an electrostatic drive method, in order to attain the high-speed printing of high-resolution pictures and the small-footprint (size) of printers, the multi-nozzling and miniaturization of ink-jet heads are advancing, along which high density of the discharging chamber (sometimes called a pressure chamber or the like) is advancing.

In the ink-jet recording device (ink-jet head) of the conventional typical electrostatic drive method, three substrates are bonded to thereby form an electrode for an electrostatic drive in one substrate, and form recesses to serve as a plurality of discharging chambers and a recess to serve as an ink cavity (sometimes called a common ink chamber or the like) in the center substrate. Moreover, the recess to serve as an ink cavity is formed in the same plane as the plane in which the recesses to serve as a plurality of discharging chambers of the center substrate are arrayed.

Japanese Unexamined Patent Publication No. 5-50601 is an example of the related art.

In the ink-jet recording device of the conventional typical electrostatic drive method (refer to the above example of the related art), there is a problem that when the discharging chamber is densified, the area of the cross-section of the discharging chamber, as the passage, becomes small and the passage resistance of the ink passage becomes high as a whole, thereby reducing the ink-discharging performance. Moreover, since the recess to serve as an ink cavity is formed in the same plane as the plane in which the recesses to serve as a plurality of discharging chambers in the center substrate are arrayed, there is a problem that the area of the ink-jet recording device would increase.

If the discharging chamber is densified as described above, the thickness of the partitioning wall between the plurality of discharging chambers becomes thin, and a pressure interference (the so-called cross talk) of the discharging chambers will occur. In the typical ink-jet head, in order to prevent this cross talk, the substrate (sometimes called a cavity substrate or the like) in which the recess to serve as the discharging chamber and the recess to serve as the common ink chamber are formed is thinned to thereby lower the height of the partitioning wall between the discharging chambers. However, if the substrate in which the recess to serve as the discharging chamber and the recess to serve as the common ink chamber are formed is thinned, the area of the cross-section of the discharging chamber would be further reduced, and for this reason, there is a problem that the passage resistance of the ink passage becomes further increased. Moreover, since the height of the common ink chamber also becomes short, the passage resistance of the common ink chamber also becomes high, and the ink supply from the common ink chamber to the discharging chamber is not carried out sufficiently in the case where there are many discharging chambers for discharging ink, and thus there is a problem that the discharging performance degrades.

### SUMMARY

An advantage of the invention is to provide a droplet-discharging head capable of securing the droplet-discharging performance while suppressing the increase of the passage resistance even if the discharging chamber is densified, and to provide a method for manufacturing the same and a droplet-discharging device provided with this droplet-discharging head having a high printing performance.

According to an aspect of the invention, a droplet-discharging head includes: a nozzle substrate in which a plurality of nozzle holes for discharging droplets are formed; a cavity substrate in which a recess to serve as a discharging chamber for pooling the droplets is formed, the recess having a diaphragm formed in a bottom face thereof an electrode substrate in which an individual electrode opposite to the diaphragm for driving the diaphragm is formed; and a reservoir substrate including a recess to serve as a common droplet chamber for supplying droplets to the discharging chamber, a penetrating hole for transporting droplets to the discharging chamber from the common droplet chamber, and a nozzle communicating hole for transporting droplets to the nozzle hole from the discharging chamber, wherein the reservoir substrate has the nozzle substrate bonded to one face thereof and has the cavity substrate bonded to the other face thereof.

As described above, the nozzle substrate, the reservoir substrate, the cavity substrate, and the electrode substrate form a four-layer structure, wherein the recess to serve as the discharging chamber is formed in the cavity substrate, and the recess to serve as the common droplet chamber is formed in the reservoir substrate, and therefore, even if the cavity substrate is thinned, the common droplet chamber can secure a sufficient height and the passage resistance of the common droplet chamber can be lowered.

Moreover, for example, if a plurality of penetrating holes for transporting droplets to the discharging chamber from the common droplet chamber are formed with respect to one discharging chamber, the passage resistance in the penetrating hole can be reduced, and the passage resistance of the whole droplet passage can be lowered.

It is preferable that a part of the common droplet chamber overlap with the discharging chamber in the direction that the nozzle substrate, the reservoir substrate, and the cavity substrate are deposited.

Since a part of the common droplet chamber overlaps with the discharging chamber in the direction that the nozzle substrate, the reservoir substrate, and the cavity substrate are deposited, the area of the droplet-discharging head can be made smaller as compared with the case where the common droplet chamber and the discharging chamber are formed in the same plane.

It is also preferable that the electrode substrate, the cavity substrate and the reservoir substrate have a droplet feed hole for supplying droplets to the common droplet chamber from the outside of the droplet-discharging head.

Since the electrode substrate, the cavity substrate, and the reservoir substrate have the droplet feed hole for supplying droplets to the common droplet chamber from the outside of the droplet-discharging head, the droplets can be supplied from the electrode substrate side, and the droplet-discharging head and the droplet feed pipe can be made compact.

It is also preferable that the nozzle communicating hole communicate with one end of the discharging chamber and the penetrating hole communicate with the other end of the discharging chamber.

Since the nozzle communicating hole communicates with one end of the discharging chamber and the penetrating hole communicates with the other end of the discharging chamber, the droplets can flow in the discharging chamber smoothly, and air bubbles or the like will not stay in the droplet passage.

It is also preferable that the penetrating hole be formed in places except for the other end of the discharging chamber.

Since the penetrating hole is also formed in places except for the other end of the discharging chamber, the passage resistance in the penetrating hole can be reduced like a parallel circuit in electric circuits.

It is also preferable that the reservoir substrate be provided with an auxiliary communicating groove for transporting droplets to the nozzle communicating hole from the common droplet chamber.

Since the reservoir substrate is provided with the auxiliary communicating groove for transporting droplets to the nozzle communicating hole from the common droplet chamber, re-filling of the droplets is carried out to the nozzle communicating hole without occupying the discharging chamber after discharging droplets. Accordingly, it is possible to reduce the time for the meniscus (a convex face of the droplets formed by capillary phenomenon) in the nozzle hole to return to the standby state, thereby allowing for a high-speed response.

It is also preferable that the nozzle substrate be provided with an auxiliary communicating groove for transporting droplets to the nozzle hole from the common droplet chamber.

Since the nozzle substrate is provided with the auxiliary communicating groove for transporting droplets to the nozzle hole from the common droplet chamber, re-filling of the droplets is carried out to the nozzle hole without occupying the discharging chamber after discharging the droplets. Accordingly, it is possible to reduce the time for the meniscus in the nozzle hole to return to the standby state, thereby allowing for the high-speed response.

According to another aspect of the invention, a method for manufacturing a droplet-discharging head includes the steps of: forming a plurality of nozzle holes for discharging droplets to a first substrate: forming a recess to serve as a discharging chamber for pooling the droplets in a second substrate so that a bottom face thereof becomes a diaphragm; forming an individual electrode for driving the diaphragm in a third substrate; forming, in a fourth substrate, a recess to serve as a common droplet chamber for supplying droplets to the discharging chamber, a recess to serve as a penetrating hole for transporting droplets to the discharging chamber from the common droplet chamber, and a nozzle communicating hole for transporting droplets to the nozzle hole from the discharging chamber; and bonding so that the fourth substrate is sandwiched by the first substrate and the second substrate, wherein the recess to serve as the common droplet chamber is formed after forming the recess to serve as the penetrating hole.

If the recess to serve as the common droplet chamber is formed in the fourth substrate after forming the recess to serve as the penetrating hole, the above-described droplet-discharging head can be manufactured easily, and the manufacturing cost can be reduced because the yield is high.

It is preferable that the method for manufacturing the droplet-discharging head further include the step of forming the nozzle communicating hole at the time of forming the recess to serve as the penetrating hole and the recess to serve as the common droplet chamber.

If the nozzle communicating hole is formed at the time of forming the recess to serve as the penetrating hole and the recess to serve as the common droplet chamber, the manufacturing process can be simplified and the manufacturing time can be reduced.

It is also preferable that the method for manufacturing the droplet-discharging head further include the step for bonding a support substrate to a face at the side, in which the recess to serve as the penetrating hole of the fourth substrate is formed, after forming the recess to serve as the penetrating hole.

Since the support substrate is bonded to a face at the side, in which the recess to serve as the penetrating hole of the fourth substrate is formed, after forming the recess to serve as the penetrating hole, the fourth substrate will not break, for example, when dry etching with ICP electric discharge, and the yield can be improved.

It is also preferable that the method for manufacturing the droplet-discharging head further include the step for forming the recess to serve as the penetrating hole and the recess to serve as the common droplet chamber by dry etching with ICP electric discharge.

If the recess to serve as the penetrating hole and the recess to serve as the common droplet chamber are formed by the dry etching with ICP electric discharge, these recesses can be formed precisely and easily.

It is also preferable that the method for manufacturing the droplet-discharging head use a single crystal silicon as a fourth substrate.

If a single crystal silicon is used as the fourth substrate, processing such as dry etching with ICP electric discharge will be carried out easily.

According to another aspect of the invention, there is provided a droplet-discharging device in which one of the above-described droplet-discharging heads is mounted

Since the above described droplet-discharging head with a low passage resistance is mounted, droplet-discharging devices with a high printing performance or the like can be obtained.

### BRIEF DESCRIPTION OF THE DRAWINGS

The invention will be described with reference to the accompanying drawings, wherein like numbers refer to like elements, and wherein:

FIG. 1 is an exploded perspective view of a droplet-discharging head concerning an first embodiment of the invention;

FIG. 2 is a longitudinal section in the state that the droplet-discharging head shown in FIG. 1 is assembled;

FIGS. 3(a) and (b) are views for explaining the passage resistance of a droplet-discharging head with the conventional typical electrostatic drive method;

FIGS. 4(a) and (b) are views for explaining the passage resistance of the droplet-discharging head concerning the invention;

FIG. 5 is a longitudinal section in the state that a droplet-discharging head concerning an second embodiment is assembled;

FIG. 6 is a longitudinal section in the state that a droplet-discharging head concerning an third embodiment is assembled;

FIG. 7 is a longitudinal section in the state that a droplet-discharging head concerning an fourth embodiment is assembled;

FIGS. 8(a)-8(d) show longitudinal sections indicative of the manufacturing process of the droplet-discharging head concerning the first embodiment;

FIGS. 9(e)-9(g) show longitudinal sections indicative of the subsequent process of the manufacturing process shown in FIG. 8; and

FIG. 10 is a perspective view showing an example of a droplet-discharging device in which one of the droplet-discharging heads of the embodiments is mounted.

### DESCRIPTION OF THE EMBODIMENTS

### First Embodiment

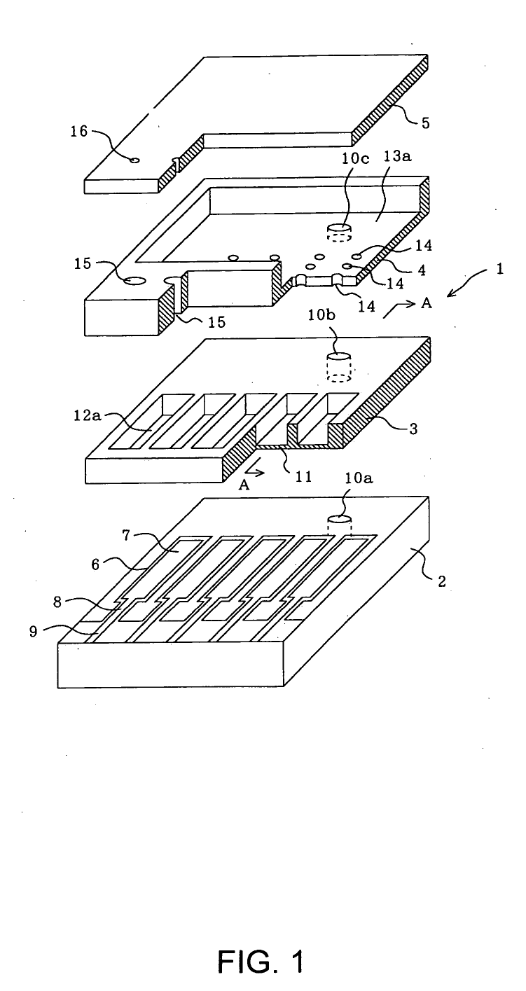

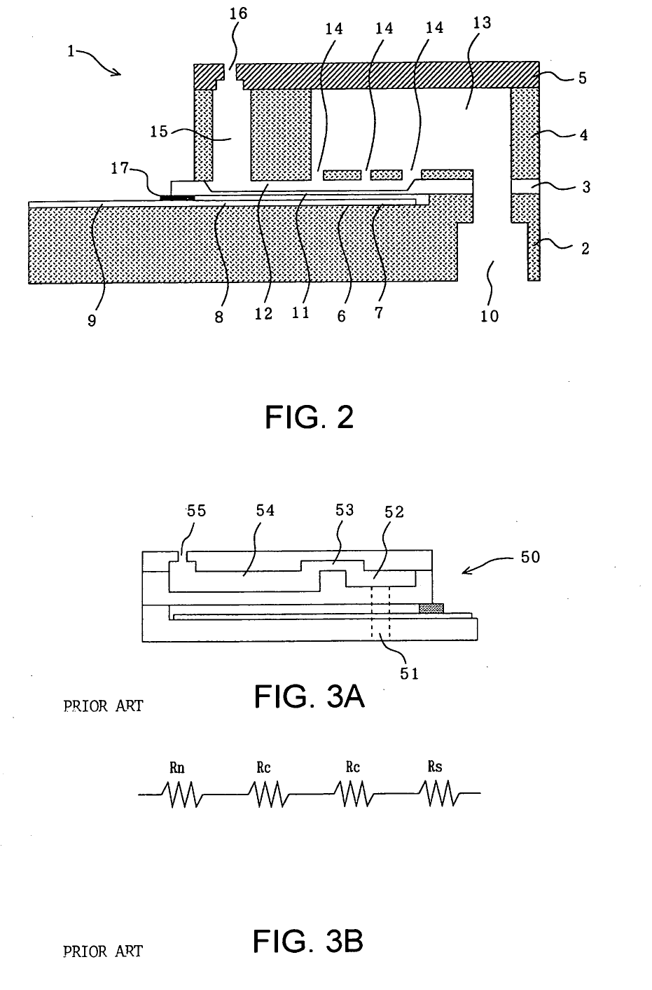

FIG. 1 is an exploded perspective view of a droplet-discharging head concerning a first embodiment of the invention, which shows a part thereof with sectional views. Moreover, FIG. 2 is a longitudinal section in the state that the droplet-discharging head shown in FIG. 1 is assembled, which shows the A-A cross section in FIG. 1.

In addition, the droplet-discharging head shown in FIG. 1 and FIG. 2 is a face eject type which discharges droplets from a nozzle hole prepared in the surface side of the nozzle substrate, and employs the electrostatic drive method driven by an electrostatic force. Hereinafter, the structure and operation of the droplet-discharging head concerning this first embodiment will be described with reference to FIG. 1 and FIG. 2.

As shown in FIG. 1, a droplet-discharging head 1 concerning this first embodiment is not configured from a three-layer structure like the droplet-discharging head (refer to the above example of the related art) of the conventional typical electrostatic drive method, but configured from four substrates: an electrode substrate 2, a cavity substrate 3, a reservoir substrate 4, and a nozzle substrate 5. The nozzle substrate 5 is bonded to one face of the reservoir substrate 4, and the cavity substrate 3 is bonded to the other face of the reservoir substrate 4. Moreover, the electrode substrate 2 is bonded to the face opposite to the face of the cavity substrate 3 to which the reservoir substrate 4 is bonded. Namely, the electrode substrate 2, the cavity substrate 3, the reservoir substrate 4, and the nozzle substrate 5 are bonded in this order.

The electrode substrate 2 is formed from glass, such as a borosilicate glass. In addition, in this first embodiment, the electrode substrate 2 is made of a borosilicate glass, however, the electrode substrate 2 may be formed from a single crystal silicon, for example.

A plurality of recesses 6 are formed, for example, to a depth of 0.3 μm in the electrode substrate 2. Inside this recess 6, an individual electrode 7 is produced by sputtering, for example, ITO (Indium Tin Oxide) to a thickness of 0.1 μm, so as to face to a diaphragm 11, which will be described later, with a constant interval put in therebetween. In the above-described example, after bonding the electrode substrate 2 and the cavity substrate 3 together, the interval between the individual electrode 7 and the diaphragm 11 will be 0.2 μm. Moreover, the individual electrode 7 is coupled with a terminal portion 9 via a lead portion 8. The terminal portion 9 is in the state of being exposed from a droplet-discharging head 10 (refer to FIG. 2), and the individual electrode 7 will be coupled to an oscillator circuit (not shown) or the like by coupling a FPC (Flexible Print Circuit) or the like with the terminal portion 9. The recess 6 is pattern-formed into a little larger shape similar to these shapes so as to be capable of mounting the lead portion 8 of the individual electrode 7.

In addition, after the electrode substrate 2 and the cavity substrate 3 are bonded together, a sealing agent 17 is applied so that foreign matters may not enter the space between the individual electrode 7 and the diaphragm 11 (refer to FIG. 2).

Moreover, a droplet feed hole 10a is formed in the electrode substrate 2, and this droplet feed hole 10a penetrates the electrode substrate 2.

The cavity substrate 3 is made of, for example, a single crystal silicon, in which a recess 12a to serve as the discharging chamber 12 whose bottom face serves as a diaphragm 11 is formed. In this first embodiment, the cavity substrate 3 is made of a single crystal silicon, entirely covered with an insulating layer (not shown) composed of TEOS (Tetra Ethyl Ortho Silicate) is formed in 0.1 μm with plasma CVD (Chemical Vapor Deposition). This is for preventing dielectric breakdown and short-circuits at the time of driving the diaphragm 11, and for preventing the cavity substrate 3 from being etched by the droplets of ink or the like.

Moreover, a droplet feed hole 10b penetrating the cavity substrate 3 is formed in the cavity substrate 3.

In addition, the diaphragm 11 of the droplet-discharging head 1 may be formed from a high concentration boron doped layer. The etching rate in etching a single crystal silicon with an alkali solution, such as a potassium hydroxide aqueous solution becomes extremely small in high-concentration regions of approximately 5×10¹⁹ atoms/cm³ or more in the case where the dopant is boron. Accordingly, the diaphragm 11 can be formed to a desired thickness by using the so-called etching stop technique in which the boron doped layer is exposed so that the etching rate becomes extremely low when the diaphragm 11 portion is formed of a high-concentration boron doped layer and the recess 12a to serve as the discharging chamber 12 is formed by anisotropic etching with an alkali solution.

The reservoir substrate 4 is made of, for example, a single crystal silicon, in which a recess 13a to serve as a common droplet chamber 13 for supplying droplets to the discharging chamber 12 is formed, and a penetrating hole 14 for transporting droplets to the discharging chamber 12 from the common droplet chamber 13 is formed in the bottom face of the recess 13a. In addition, in this first embodiment, three penetrating holes 14 are formed in each discharging chamber 12, and one of these three penetrating holes 14 communicates with one end of the discharging chamber 12 (refer to FIG. 2).

Moreover, in the bottom face of the recess 13a, a droplet feed hole 10c penetrating the bottom face of the recess 13a is formed. The droplet feed hole 10c formed in this reservoir substrate 4, the droplet feed hole 10b formed in the cavity substrate 3, and the droplet feed hole 10a formed in the electrode substrate 2 are mutually connected in the state that the reservoir substrate 4, the cavity substrate 3, and the electrode substrate 2 are bonded together and form a droplet feed hole 10 for supplying droplets to the common droplet chamber 13 from the outside (refer to FIG. 2).

As shown in FIG. 2, a part of the common droplet chamber 13 is overlapping with the discharging chamber 12 in the direction that the nozzle substrate 5, the reservoir substrate 4, and the cavity substrate 3 are bonded and deposited (in the vertical direction of FIG. 2). Namely, a part of the common droplet chamber 13 and the discharging chamber 12 are deposited in the vertical direction of FIG. 2. With such a structure, the area of the droplet-discharging head 1 can be made smaller as compared with the case where the common droplet chamber 13 and the discharging chamber 12 are formed in the same plane (refer to FIG. 3(a)).

Moreover, in portions except the recess 13a of the reservoir substrate 4, the nozzle communicating hole 15, which communicates with each discharging chamber 12 for transporting droplets to a nozzle hole 16 described later from the discharging chamber 12, is formed. This nozzle communicating hole 15 penetrates the reservoir substrate 4, and communicates with one end at the opposite side of one end with which the penetrating hole 14 of the discharging chamber 12 communicates (refer to FIG. 2).

The nozzle substrate 5 is made of a silicon substrate with a thickness of 100 μm, for example, in which a plurality of nozzle holes 16 communicating with the respective nozzle communicating holes 15 are formed. In addition, in this first embodiment, the progressiveness at the time of discharging droplets is improved with the nozzle hole 16 being formed in two stages (refer to FIG. 2).

In addition, when the above described electrode substrate 2, the cavity substrate 3, the reservoir substrate 4, and the nozzle substrate 5 are bonded together, the bonding can be carried out by anode bonding in the case where a substrate made of silicon is bonded to a substrate made of a borosilicate glass, and it can be carried out by direct bonding in the case where the substrates made of silicon are bonded together. Moreover, the substrates made of silicon can be bonded also using adhesives.

The operation of the droplet-discharging head shown in FIG. 1 and FIG. 2 will be described. Droplets, such as ink are supplied to the common droplet chamber 13 through the droplet feed hole 10 from the outside. Moreover, the droplets are supplied to the discharging chamber 12 through the penetrating hole 14 from the common droplet chamber 13. If a pulse voltage in an approximate range from 0V to 40V is applied to the individual electrode 7 via the lead portion 8 by means of the oscillator circuit (not shown) that is coupled with the terminal portion 9, then the individual electrode 7 is charged plus (positively charged), the corresponding diaphragm 11 is charged minus (negatively charged), and the diaphragm 11 will be attracted to the individual electrode 7 side by an electrostatic force, and will be bent. Next, if the pulse voltage is turned off, then the electrostatic force applied to the diaphragm 11 will disappear, and the diaphragm 11 will be restored. At this time, the pressure inside the discharging chamber 12 increases rapidly, and the droplets in the discharging chamber 12 will pass through the nozzle communicating hole 15, and will be discharged from the nozzle hole 16. Then, the pulse voltage is applied again, and then the diaphragm 11 will bend toward the individual electrode 7 side, whereby the droplets are refilled in the discharging chamber 12 through the penetrating hole 14 from the common droplet chamber 13.

In addition, the connection between the cavity substrate 3 and the oscillator circuit is made with a common electrode (not shown) which is opened in a part of the cavity substrate 3 by dry etching. Moreover, a supply of the droplets to the common droplet chamber 13 of the droplet-discharging head 1 is carried out through a droplet feed pipe (not shown) coupled to the droplet feed hole 10, for example.

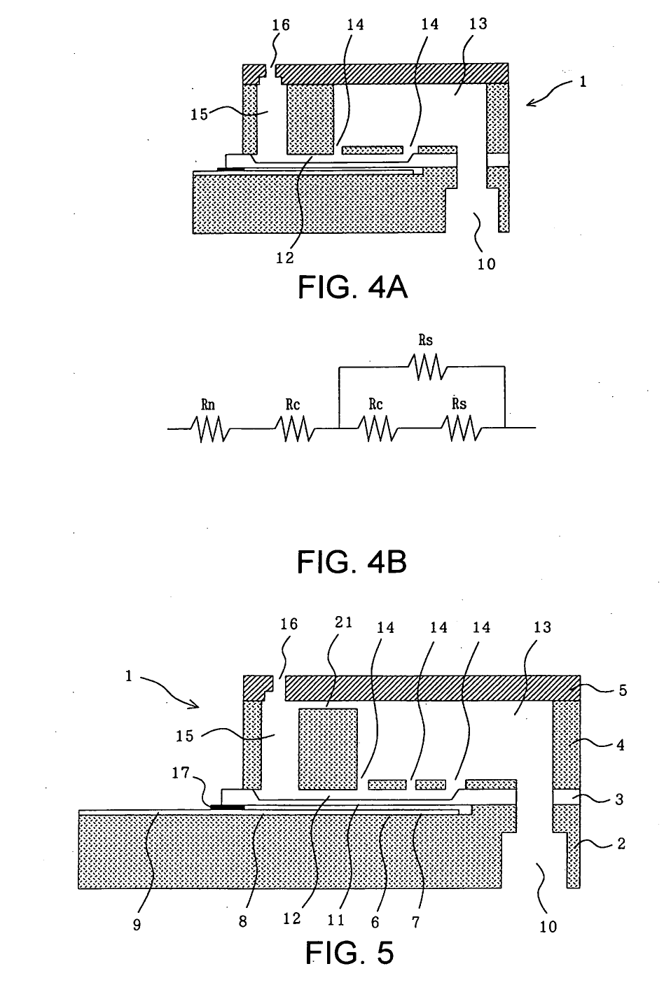

FIG. 3 is a view for explaining the passage resistance of a droplet passage of a droplet-discharging head with the conventional typical electrostatic drive method. Moreover, FIG. 4 is a view for explaining the passage resistance of a droplet passage of the droplet-discharging head concerning the invention. FIG. 3(a) is a longitudinal section of the droplet-discharging head of the electrostatic drive method with the conventional three-layer structure, and FIG. 3(b) is a view indicating the passage resistance of this conventional droplet-discharging head as an electric circuit. Moreover, FIG. 4(a) is the longitudinal section of the droplet-discharging head concerning the invention, and FIG. 4(b) is a view indicating the passage resistance of the droplet-discharging head concerning the invention as an electric circuit. In addition, in FIG. 4, for simplification of the description, assuming that two penetrating holes 14 are formed respectively in each discharging chamber 12, one penetrating hole 14 communicating with one end of the discharging chamber 12, another penetrating hole 14 communicating with the center of the discharging chamber 12 (refer to FIG. 4(a)). Moreover, in FIG. 3 and FIG. 4, the passage resistance of the common droplet chamber will not be taken into consideration.

In a droplet-discharging head 50 of the conventional electrostatic drive method shown in FIG. 3(a), droplets, such as ink are supplied to a common droplet chamber 52 from a droplet feed hole 51, and the droplets are supplied to a discharging chamber 54 from the common droplet chamber 52 through an orifice 53. Then, the droplets to which a pressure is applied in the discharging chamber 54 will be discharged from a nozzle hole 55.

The overall passage resistance Ra of the droplet-discharging head 50 shown in FIG. 3 is expressed as Ra=Rn+2Rc+Rs, denoting the passage resistance of the nozzle hole 55 by Rn, one half value of the passage resistance of the discharging chamber 54 by Rc, and the passage resistance of the orifice 53 by Rc. This is because the respective passage resistances are added in series as shown in FIG. 3 (b).

On the other hand, the overall passage resistance Rb of the droplet-discharging head 1 concerning the invention shown in FIG. 4 (a) is expressed as Rb=Rn+2Rc+Rs(Rc+Rs)/(Rc+2Rs), denoting the passage resistance of a nozzle hole 16 by Rn, one half value of the passage resistance of the discharging chamber 12 by Rc, and the passage resistance of the penetrating hole 14 by Rs. This is because a plurality of penetrating holes 14 are formed so that the passage resistance is added in parallel as shown in FIG. 4 (b).

Comparing the above-described passage resistance Ra with Rb, the relationship of Ra>Rb is always valid, and it is therefore apparent that the overall passage resistance of the droplet-discharging head 1 concerning the invention is smaller than the overall passage resistance of the droplet-discharging head 50 of the conventional electrostatic drive method. In addition, the passage resistance Rb can be further reduced by increasing the number of the penetrating holes 14.

In this first embodiment, a four-layer structure of the nozzle substrate 5, the reservoir substrate 4, the cavity substrate 3, and the electrode substrate 2 is formed, and since the recess 12a to serve as the discharging chamber 12 is formed in the cavity substrate 3 and the recess 13a to serve as the common droplet chamber 13 is formed in the reservoir substrate 4, the common droplet chamber 13 can secure a sufficient height even if the cavity substrate 3 is thinned, and thus the passage resistance of the common droplet chamber 13 can be lowered.

Moreover, since a plurality of penetrating holes 14 for transporting droplets to the discharging chamber 12 from the common droplet chamber 13 are formed in one discharging chamber 12, the passage resistance in the penetrating hole 14 can be reduced and the overall passage resistance of the droplet passage can be lowered.

Furthermore, since a part of the common droplet chamber 13 is overlapping with the discharging chamber 12 in the direction that the nozzle substrate 5, the reservoir substrate 4, and the cavity substrate 3 are deposited, the area of the droplet-discharging head 1 can be made small as compared with the case where the common droplet chamber 13 and the discharging chamber 12 are formed in the same plane.

### Second Embodiment

FIG. 5 is a longitudinal section in the state that a droplet-discharging head concerning a second embodiment of the invention is assembled. In addition, in the droplet-discharging head 1 shown in FIG. 5, there is only one penetrating hole 14 communicating between the discharging chamber 12 and the common droplet chamber 13, and this penetrating hole 14 communicates with one end of the discharging chamber 12. Moreover, the common droplet chamber 13 is hardly overlapping with the discharging chamber 12 in the direction that the nozzle substrate 5, the reservoir substrate 4, and the cavity substrate 3 are deposited. Since the other structures and operations are the same as those of the droplet-discharging head 1 shown in FIG. 1 and FIG. 2 of the first embodiment, the description thereof will be omitted. Moreover, the same numerals are assigned to the same components as those of the droplet-discharging head 1 concerning the first embodiment.

In the droplet-discharging head 1 concerning this second embodiment, as compared with the droplet discharging head 1 concerning the first embodiment, there are not big advantages in reduction of the passage resistance due to the plurality of penetrating holes 14, and in miniaturization of the droplet-discharging head 1 due to the fact that the discharging chamber 12 and the common droplet chamber 13 vertically overlap. However, since the recess 12a to serve as the discharging chamber 12 is formed in the cavity substrate 3, and the recess 13a to serve as the common droplet chamber 13 is formed in the reservoir substrate 4, the common droplet chamber 13 can secure a sufficient height even if the cavity substrate 3 is thinned, and thus the passage resistance of the common droplet chamber 13 can be lowered.

Moreover, the electrode substrate 2, the cavity substrate 3, and the reservoir substrate 4 have the droplet feed hole 10a or the like, and the droplets are supplied to the common droplet chamber 13 from the outside through the droplet feed hole 10, and therefore, the droplets can be supplied from the electrode substrate 2 side, thereby allowing for the droplet-discharging head 1 and the droplet feed pipe (not shown) to be made compact.

### Third Embodiment

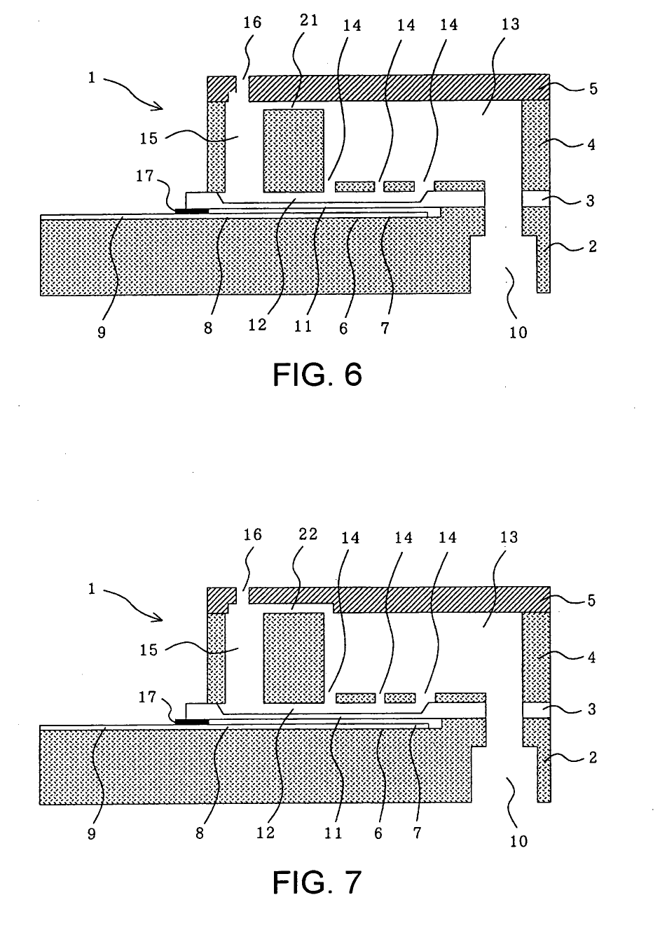

FIG. 6 is a longitudinal section in the state that a droplet-discharging head concerning an third embodiment of the invention is assembled. In addition, in the droplet-discharging head 1 shown in FIG. 6, an auxiliary communicating groove 21 for transporting droplets to the nozzle communicating hole 15 from the common droplet chamber 13 is formed in the reservoir substrate 4. Since the other structures and operations are the same as those of the droplet-discharging head 1 shown in FIG. 1 and FIG. 2 of the first embodiment, the description thereof will be omitted. Moreover, the same numerals are assigned to the same components as those of the droplet-discharging head 1 concerning the first embodiment.

In this third embodiment, since the auxiliary communicating groove 21 for transporting droplets to the nozzle communicating hole 15 from the common droplet chamber 13 is formed in the reservoir substrate 4, re-filling of the droplets is carried out to the nozzle communicating hole 15 without via the discharging chamber 12 after discharging the droplets. Accordingly, it is possible to reduce the time for the meniscus (a convex face of droplets formed by capillary phenomenon) in the nozzle hole 16 to return to the standby state, thereby allowing for a high-speed response. The other advantages are the same as those of the droplet-discharging head 1 concerning the first embodiment.

### Fourth Embodiment

FIG. 7 is a longitudinal section in the state that a droplet-discharging head concerning an fourth embodiment of the invention is assembled. In addition, in the droplet-discharging head 1 shown in FIG. 7, an auxiliary communicating groove 22 for transporting droplets to the nozzle hole 16 from the common droplet chamber 13 is formed in the nozzle substrate 5. Since the other structures and operations are the same as those of the droplet-discharging head 1 shown in FIG. 1 and FIG. 2 of the first embodiment, the description thereof will be omitted. Moreover, the same numerals are assigned to the same components as those of the droplet-discharging head 1 concerning the first embodiment.

In this fourth embodiment, since the auxiliary communicating groove 22 for transporting droplets to the nozzle hole 16 from the common droplet chamber 13 is formed in the nozzle substrate 5, re-filling of droplets is carried out to the nozzle hole 16 without via the discharging chamber after discharging droplets. Accordingly, like the third embodiment, it is possible to reduce the time for the meniscus in the nozzle hole 16 to return to the standby state, thereby allowing for a high-speed response. The other advantages are the same as those of the droplet-discharging head 1 concerning the first embodiment.

### Fifth Embodiment

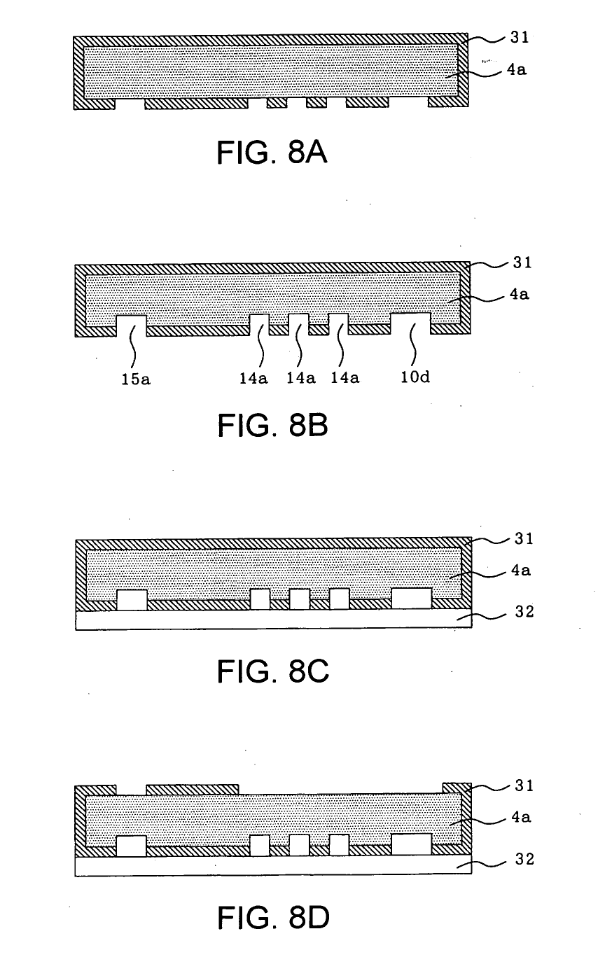

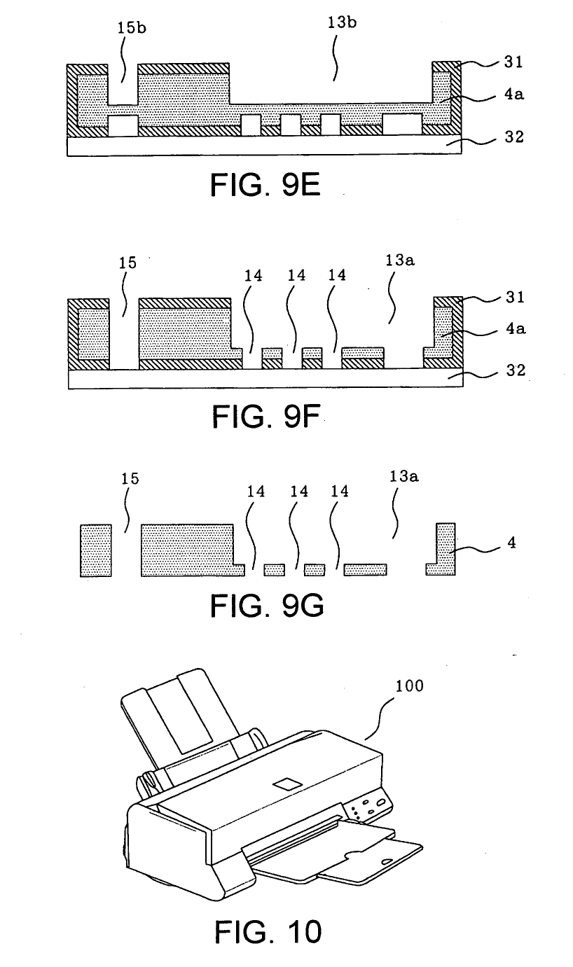

FIG. 8 and FIG. 9 are a longitudinal section showing the manufacturing process of the droplet-discharging head shown in FIG. 1 and FIG. 2 of the first embodiment. In this fifth embodiment, the manufacturing process of the reservoir substrate 4 of the droplet-discharging head 1 of the first embodiment will be described, and as to the electrode substrate 2, the cavity substrate 3, and the nozzle substrate 5, the manufacturing method thereof is the same as that of the conventional droplet-discharging head, so the description thereof will be omitted (refer to the above example of the related art).

First, a material substrate 4a made of, for example, a single crystal silicon is prepared, and an etching mask 31 made of a silicon oxide is then formed all over the material substrate 4a with thermal oxidation or the like. Then, by patterning a resist in the surface of the material substrate 4a and then etching it with hydrofluoric acid or the like, the etching mask 31 in portions corresponding to the droplet feed hole 10c, the penetrating hole 14, and the nozzle communicating hole 15 in one surface of the material substrate 4a are removed (FIG. 8 (a)).

Next, the material substrate 4a is etched, for example, by dry etching with ICP (Inductively Coupled Plasma) electric discharge, and the recess 10d to serve as the droplet feed hole 10c, the recess 14a to serve as the penetrating hole, and the recess 15a to serve as the nozzle communicating hole 15a are formed (FIG. 8(b)). In addition, a wet etching with a potassium hydroxide aqueous solution or the like may be carried out in place of the dry etching with ICP electric discharge.

Then, a support substrate 32 is fixed to a face in which the recess 14a to serve as the penetrating hole of the material substrate 4a and the like are formed (FIG. 8(c)) by a resist or the like. As this support substrate 32, a glass substrate and a silicon substrate can be used, for example.

Then, by patterning a resist in the surface of the material substrate 4a and etching it with a hydrofluoric-acid aqueous-solution or the like, the etching mask 31 in portions corresponding to the common droplet chamber 13 and the penetrating hole 14 in the face opposite to the face to which the support substrate 32 is bonded is removed (FIG. 8 (d)).

Then, by etching the material substrate 4a, for example, by dry etching with ICP electric discharge, the recess 13b to serve as the common droplet chamber 13 and the recess 15b to serve as the nozzle communicating hole 15 are formed in the face opposite to the face to which the support substrate 32 is bonded (FIG. 9 (e)).

Subsequently, by carrying out dry etching with ICP electric discharge, the recess 13b to serve as the common droplet chamber 13 will communicate with the recess 14a to serve as the penetrating hole 14 each other, thereby forming the recess 13a to serve as the common droplet chamber 13 and the penetrating hole 14. Moreover, the recess 15a to serve as the nozzle communicating hole 15 communicates with the recess 15b to serve as the nozzle communicating hole 15, thereby forming the nozzle communicating hole 15 (FIG. 9 (f)).

Finally, the support substrate 32 is removed from the material substrate 4a, and all the etching masks 31 are removed, for example, with a hydrofluoric-acid aqueous solution, whereby the reservoir substrate 4 is completed (FIG. 9 (g)). In addition, subsequently, a droplet protective film composed of TEOS (Tetra Ethyl Ortho Silicate) or the like may be formed for preventing etching by the droplets, such as ink. Moreover, typically, a plurality of reservoir substrates 4 are manufactured from one material substrate 4a, and each reservoir substrate 4 is cut out by dicing.

In this fifth embodiment, since the recess 13a to serve as the common droplet chamber 13 is formed after forming the recess 14a to serve as the penetrating hole 14 in the material substrate 4a to serve as the reservoir substrate 4, the above-described droplet-discharging head can be manufactured easily, and the manufacturing cost can be reduced because the yield is high.

Moreover, since the nozzle communicating hole 15 is formed simultaneously at the time when forming the recess 14a to serve as the penetrating hole 14 and the recess 13a to serve as the common droplet chamber 13, the manufacturing process can be simplified and the manufacturing time can be reduced.

Furthermore, since the support substrate 32 is bonded to the face at the side in which the recess 14a to serve as the penetrating hole 14 of the material substrate 4a is formed after forming the recess 14a to serve as the penetrating hole 14, the material substrate 4a will not break in dry etching with ICP electric discharge, enabling improvement of the yield.

### Sixth Embodiment

FIG. 10 is a perspective view showing an example of a droplet-discharging device in which one of the droplet-discharging heads of the embodiments 1 to 4 is mounted. In addition, a droplet-discharging device 100 shown in FIG. 10 is a typical ink-jet printer.

Since the droplet-discharging head 1 concerning the first embodiment to the fourth embodiment has a low passage resistance as described above, the droplet-discharging device 100 has a high printing performance or the like

In addition, the droplet-discharging head 1 concerning the first embodiment to the fourth embodiment can be applied to manufacturing of color filters of liquid crystal displays, forming of luminescence portions of organic electroluminescence display devices, and discharging of bio-liquid or the like by modifying the droplet variously, other than to the ink jet printer shown in FIG. 10.

In addition, the droplet-discharging head, the method for manufacturing the same, and the droplet-discharging device of the invention are not limited to the above embodiments of the invention, and can be modified without departing from the spirit and scope of the invention. For example, four or more penetrating holes 14 may be formed with respect to each discharging chamber 12.

What is claimed is:

1. A droplet-discharging head, comprising:
a nozzle substrate including a plurality of nozzle holes for discharging droplets;
a cavity substrate including a recess serving as a discharging chamber for pooling the droplets, the recess having a diaphragm formed in a bottom face thereof;
an electrode substrate including an individual electrode opposite to the diaphragm for driving the diaphragm; and
a reservoir substrate having a recess to serve as a common droplet chamber for supplying droplets to the discharging chamber, a penetrating hole for transporting droplets to the discharging chamber from the common droplet chamber, and a nozzle communicating hole for transporting droplets to the nozzle hole from the discharging chamber, wherein
the reservoir substrate has the nozzle substrate bonded to one face thereof and has the cavity substrate bonded to the other face thereof.

2. The droplet-discharging head according to claim 1, wherein a part of the common droplet chamber overlaps the discharging chamber in a direction that the nozzle substrate, the reservoir substrate, and the cavity substrate are deposited.

3. The droplet-discharging head according to claim 2, wherein the electrode substrate, the cavity substrate, and the reservoir substrate have a droplet feed hole for supplying droplets to the common droplet chamber from the outside of the droplet-discharging head.

4. The droplet-discharging head according to claim 1, wherein the nozzle communicating hole communicates with one end of the discharging chamber, and the penetrating hole communicates with the other end of the discharging chamber.

5. The droplet-discharging head according to claim 4, wherein the penetrating hole is also formed in places except for the other end of the discharging chamber.

6. The droplet-discharging head according to claim 1, wherein the reservoir substrate is provided with an auxiliary communicating groove for transporting droplets to the nozzle communicating hole from the common droplet chamber.

7. The droplet-discharging head according to claim 1, wherein the nozzle substrate is provided with an auxiliary communicating groove for transporting droplets to the nozzle hole from the common droplet chamber.

8. A method for manufacturing a droplet-discharging head, comprising:
forming a plurality of nozzle holes for discharging droplets in a first substrate:
forming a recess to serve as a discharging chamber for pooling the droplets in a second substrate so that a bottom face thereof becomes a diaphragm;
forming an individual electrode for driving the diaphragm in a third substrate;
forming, in a fourth substrate, a first recess serving as a common droplet chamber for supplying droplets to the discharging chamber, a second recess to serve as a penetrating hole for transporting droplets to the discharging chamber from the common droplet chamber, and a nozzle communicating hole for transporting droplets to the nozzle hole from the discharging chamber; and
bonding so that the fourth substrate is sandwiched by the first substrate and the second substrate, wherein
the first recess to serve as the common droplet chamber is formed after forming the second recess to serve as the penetrating hole.

9. The method for manufacturing a droplet-discharging head according to claim 8, further comprising forming the nozzle communicating hole at the time of forming the second recess to serve as the penetrating hole and the first recess to serve as the common droplet chamber.

10. The method for manufacturing a droplet-discharging head according to claim 8, further comprising bonding a support substrate to a face at the side in which the second recess to serve as the penetrating hole of the fourth substrate is formed after forming the second recess to serve as the penetrating hole.

11. The method for manufacturing the droplet-discharging head according to claim 8, further comprising forming the second recess to serve as the penetrating hole and the first recess to serve as the common droplet chamber by dry etching with ICP electric discharge.

12. The method for manufacturing a droplet-discharging head according to claim 8, wherein the fourth substrate further comprises a single crystal silicon.

13. A droplet-discharging device in which the droplet-discharging head according to claim 1 is mounted.
